(19) United States
(12) Patent Application Publication
(10) Pub. No.: US 2022/0106200 A1
(43) Pub. Date: Apr. 7, 2022

(54) SYSTEMS AND DEVICES OF A FOAM FILTER HOUSING

(71) Applicant: ZERO TECHNOLOGIES, LLC, Trevose, PA (US)

(72) Inventors: Robert PETNER, Trevose, PA (US); Anthony PETRUZZI, Trevose, PA (US)

(21) Appl. No.: 17/492,812

(22) Filed: Oct. 4, 2021

Related U.S. Application Data
(60) Provisional application No. 63/088,577, filed on Oct. 7, 2020.

(51) Int. Cl. C02F 1/00

(52) U.S. Cl. CPC C02F 1/003; C02F 2201/004; C02F 2201/006; C02F 2307/04

(57) ABSTRACT

The claimed invention relates to systems, devices, and methods of using the devices for fast flow and reduced waste over the lifespan of a permeable filter. The invention includes a fluid filtering system with a fluid reservoir with a cavity and lid to capture a permeable filter. The permeable filter is easily replaceable.

This application claims the benefit of U.S. Provisional Application No. 63/088,577, filed Oct. 7, 2020, which is incorporated herein by reference in its entirety.

### TECHNICAL FIELD

This technology relates to systems, devices, and methods of use of the devices to use of a permeable fast flowing filter. More particularly, the technology relates to systems and devices to remove contaminants from a fluid.

### BACKGROUND

Water filtration systems can include pour-through pitcher systems, countertop systems, and filtration cartridge systems. Pour-through pitcher systems can include an upper reservoir for receiving unfiltered water, a lower reservoir for receiving and storing filtered water, and a filtration cartridge with an inlet at its top and an outlet at its bottom, through which water flows from the upper reservoir, is filtered, and travels to the lower reservoir.

Countertop or standalone systems can include a larger filtered water tank with a spigot for dispensing filtered water into a glass or other container. Pitcher and countertop systems use gravity to move the unfiltered water in the top reservoir through a water filter and filtration cartridge and into the lower reservoir where the filtered water is stored until it is used.

Water reservoirs used in gravity flow systems often include a sieve system. The sieve system is often sealed into the water reservoir to prevent unfiltered water from entering the filtered water storage. The filtration systems generally include a filtration media that is usually granular to allow a sedimented sieve filtering.

A problem associated with water reservoir systems using granular filtration media is that such media requires a housing to contain the media, which is generally replaced with the filtration media once the filter has met its product lifetime. In other words, the filter waste includes the housing and granular filtration media. The use of foam or other permeable filtration media to remove certain contaminants and reduces waste, makes replacement simpler, and may increase the flow rate of filtration.

### SUMMARY

The devices and systems of the invention provide improvements in fluid filtration waste material and fluid flow rate during filtration. The use of permeable filter devices introduces different requirements to filter certain contaminants, and thus requires different fluid reservoirs to configure the fluid filtration system for use with permeable filter devices. Improved waste reduction and flow rate, while preventing entry of unfiltered fluids from the fluid reservoir from entry to filtered fluid storage.

The water reservoirs of the invention reduce waste by limiting the disposable parts for use in filtration systems. The permeable filters and filtration reservoirs of the invention remove a broad range of contaminants in water as it is gravity-fed or pressure-fed through the permeable filters. The water filtration system of the invention includes a permeable filter that separate or removes organic, inorganic, radiological, and microbiological contaminants from unfiltered water.

The invention provides a reservoir for which permeable filters may be used to filter a wide range of contaminants, is easily replaceable, and allows for a faster flow rate. For example, by using a permeable filter, with a water head of 75 mm, a flow rate of water greater than 180-200 ml/min can be achieved. The water head describes an amount of unfiltered water held in a water reservoir, above the permeable filter, of a filtration device such as a pitcher. One example reservoir includes a locking lid, permeable filter, and reservoir cavity sealed with the lid, captures the permeable filter.

Different geometries and material properties of the permeable filter can be employed depending upon the particular application in which the permeable filter will be used. For example, one embodiment of the permeable filter includes graduated permeability. In other embodiments, the permeable filter includes a filter that prevents backflow from the filter exit. Further geometries may include a single body permeable filter. In other embodiments, the permeable filter includes cylindrical, cubic, rectangular prism, conical, pyramid-shaped, or other geometric shaped and non-geometric shaped filters (e.g., heart-shaped) generally based on the shape of the reservoir for even feed of water to the filter.

The permeable filter of the invention does not use sedimented or granular filtration media in order to easily replace the permeable filter without mess. The permeable filter is commonly made of a foam and may include a number of separable or combined layers, however the layers are easily inserted and removed from the reservoir.

The permeable filter may be made of permeable fibers, impregnated fiber, or a sponge material. The permeable filter may include a single or plurality of layers of foam. For example, the permeable filter includes an organic element and oxidation reduction filter layer, such as a carbon layer for removing chlorine and/or organic contaminants from the unfiltered water. The permeable filter can also include a mold and mildew prevention layer, such as redox alloy layer that neutralizes pH in the water.

Additionally, the permeable filter can include an inorganic element filter layer, such as an ion exchange layer for removing inorganic and/or radiological contaminants in the water. The ion exchange layer can include a mixed bed of cationic and anionic resins. Likewise, the ion exchange layer can include a water softener.

One example embodiment includes a permeable filter where the water (or other liquid) runs both transverse to and along the longitudinal axis of the filter from a water inlet proximate to a first end of the water filter to a water outlet proximate to another end of the water filter. The permeable filter is a gravity-fed filter. Some embodiments include a permeable filter that also includes a food safe foam that is configured to provide a permeable pathway for unfiltered water to become filtered.

One example of the invention includes a method of using a locking lid to contain the permeable filter in the water reservoir and direct unfiltered water to the permeable filter. The method of use includes treating unfiltered water to remove organic, inorganic, and/or radiological contaminants from the unfiltered water using a permeable filter of the invention to produce potable water suitable for human consumption. The methods include passing untreated water through the water permeable filter to produce potable water suitable for human consumption while reducing waste and the mess of particulate filter medias by using a permeable filter. As outlined above, filtered water passes through a permeable filter and exits the water permeable filter from the reservoir outlet. Once the water passes through the permeable filter and exits from the water outlet, the potable water is collected.

In passing untreated water through the water permeable filter, a variety of contaminants and impurities are removed. For example, the method of using the permeable filter includes removing chlorine and/or organic contaminants from the unfiltered water with a carbon layer in the permeable filter, neutralizing pH in the water with a redox alloy layer, removing inorganic and/or radiological contaminants in the water with an ion exchange layer, and eliminating discharge of the permeable filter into the output water and filtering out elements larger than one micron with a micron filter layer.

A method of using a locking lid for capturing and compressing the water permeable filter to treat unfiltered water can also include softening the water with a water softener in the ion exchange layer of the permeable filter. The compressed permeable filter seals filtered water from the unfiltered water to prevent contamination. In some embodiments, the locking lid may include a separate top seal for sealing the locking lid to the reservoir cavity containing the permeable filter. The locking lid may also include a filter seal to seal the space between the filter and the locking lid with less compression of the permeable filter than without a filter seal. The bottom of the reservoir cavity may also include a bottom seal, near the filter outlet, between the reservoir cavity and the permeable filter to seal unfiltered water from the input side of the filter from the filtered water on the output side of the filter with less compression than without a bottom seal.

The permeable filters of the invention can be integrated into containers that house and store filtered water to form water treatment apparatuses. These water containers can be in fluid communication with the water permeable filter to receive and collect the filtered water from the water outlet on the filter. The filter removes organic, inorganic, and radiological contaminants from the unfiltered water to produce potable water. The filtered, potable water can be stored in the water container for future use. Example water containers that can be integrated with the water filters of the invention include pitchers, travel bottles, sports bottles, water coolers, water jugs, and water bottles.

### BRIEF DESCRIPTION OF THE DRAWINGS

FIG. 1 shows a side view of one example embodiment of a filtration system in accordance with the invention.

FIGS. 2A and 2B show an exploded perspective side rear view and an exploded side view, respectively, of a filtration system in accordance with the invention.

FIG. 3 shows a top view of one example embodiment of a water reservoir with locking lid in accordance with the invention.

FIG. 4 shows a top side perspective view of one example embodiments of a water reservoir with inserted permeable filter in accordance with the invention.

FIG. 5 shows a top view of one example embodiments of a water reservoir in accordance with the invention.

FIG. 6 shows a top side perspective view of a water reservoir in accordance with the invention.

FIG. 7 shows a bottom perspective view of a locking lid in accordance with the invention.

FIG. 8 shows a top perspective view of a locking lid in accordance with the invention.

FIGS. 9A and 9B show a side cut away view and side perspective cut away view, respectively, of a locking lid in accordance with the invention.

FIG. 10 shows a bottom perspective view of a locking lid with permeable filter inserted in accordance with the invention.

FIG. 11 shows a number of example water containers and integrated water table retention filters in accordance with the invention.

### DETAILED DESCRIPTION

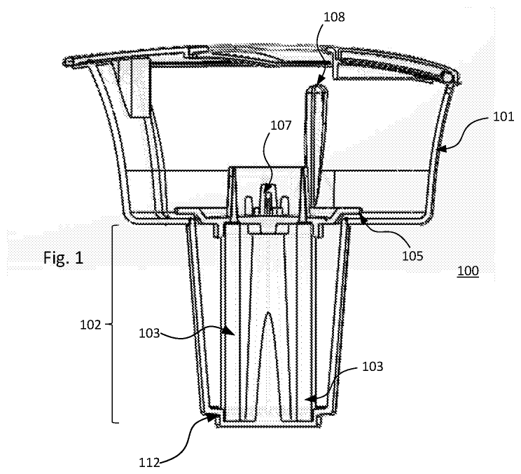

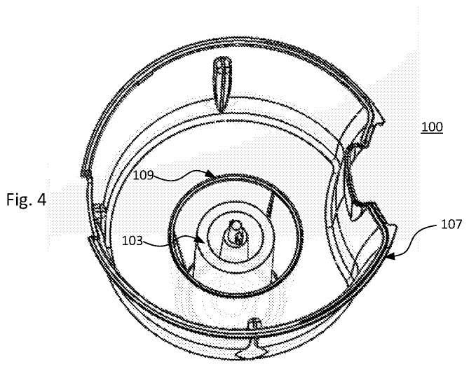

With the example embodiments shown in FIGS. 1-10, the invention uses a water reservoir 101 capturing a permeable filter 103 with a locking lid 105. As unfiltered water is added to a reservoir of a water filtration system 100, the water is directed with the force of gravity and water weight through the locking lid 105, into the reservoir cavity 102 and through the permeable filter 103 to a reservoir outlet. The filtered water exits the water reservoir 101 and can be transferred, stored, consumed, and the like. As additional unfiltered water is added to the reservoir 101, the water's weight and gravity feed the unfiltered water through the permeable filter 103. In this fashion, the filter system 100 of the invention provides reduced waste and increased flow rate of filtered water by the permeable filter 103.

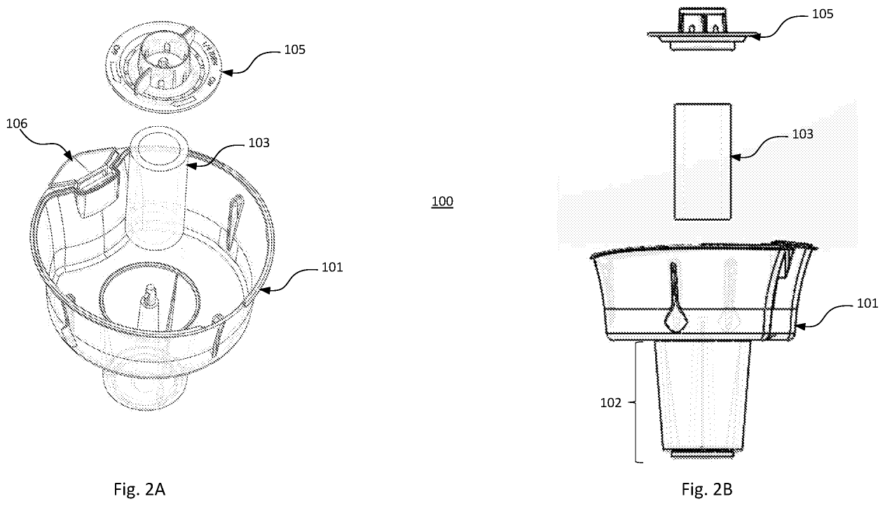

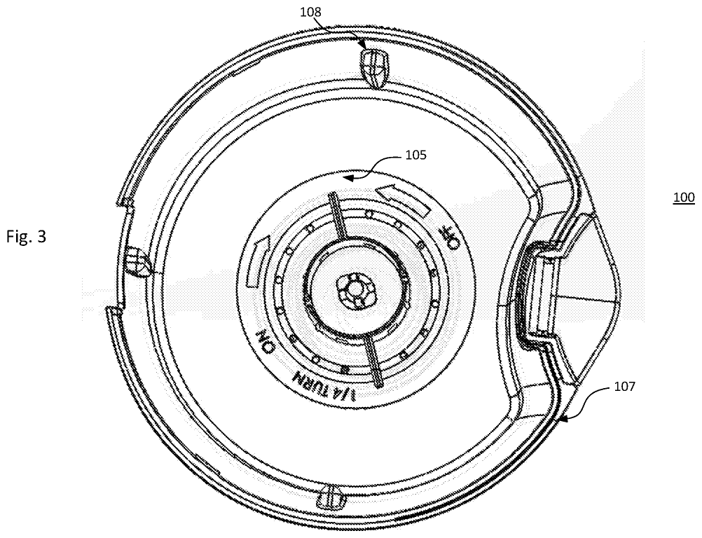

A number of example embodiments in accordance with the invention can be used to provide liquid filtration. One example filtration system 100 is shown in FIG. 1. Filter system 100 is also shown in front view, cross-sectional side view, top view, bottom view, and front perspective and side exploded views, respectively, in FIGS. 2A and 2B, and in various separated forms in FIGS. 3-10. In the example embodiment of the invention shown in FIG. 1 the liquid (e.g., water) enters the filtration system 100 from the lid 105 that covers the top of housing 107. The lid 105 and reservoir 101 define the filter cavity 102 that contains the permeable filter 103. Water enters the filtration system 100 from the lid 105. Specifically, unfiltered water enters the filtration system 100 through holes in the lid 105. The lid 105 locking structure which mates with a locking structure of the reservoir 101. The water entering from the top of the lid 105 and then passing from an exterior portion of the permeable filter 103 to an interior portion of the permeable filter 103 to filter impurities in the water to a reservoir outlet for potable water storage.

Reservoir

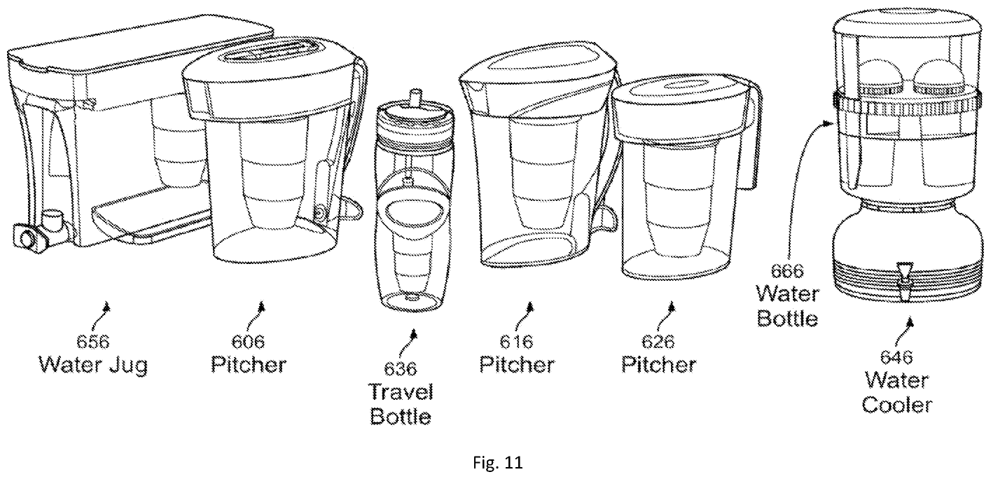

As shown in the Figures, reservoir 101 and lid 105 can be manufactured as polypropylene outer cases within which the permeable filter 103 is contained. Though the discussion below and the exemplary figures refer to a certain foam permeable filter 103 for the exemplary embodiments, any permeable filter for purification and treatment of water, or combinations of permeable filter with various layers known in the art can be used in accordance with the invention. The reservoir 101, best seen in FIGS. 1, 2A, 2B, and 4-6, may include a reservoir cavity 102, filtered water spout 106, reservoir support structure 108, reservoir lid-cavity seal 109, reservoir outlet 110, reservoir compression ridges 111, filter recess 112, vertical filter post 113, and mating post lock 121. The reservoir support structure 108 and spout 106 are configured for various geometries of water filter systems 100. The structure 108 and spout 106 provide structural support to the side walls of the reservoir 101 and prevent contamination of filtered water upon distribution, respectively. The spout 106 and sidewalls of the reservoir 101 are configured to mate with a water filtering system or device described in FIG. 11.

The example filtration system 100 of the invention shown in the Figures is designed and manufactured with a water reservoir 101 defined by side walls that direct the water through the filtration system 100 into a lid 105 to the permeable filter 103, and filtered through to a filtered water reservoir outlet 110. The reservoir 101 contains the permeable filter 103 described above to remove impurities in the water. As shown in FIGS. 1 and 2B, in some embodiments, the reservoir 101 may include a seal at the bottom of the reservoir cavity 102 to seal the permeable filter 103 when captured in the reservoir 101. In some embodiments, the reservoir cavity 102 includes a filter recess 112 for trapping the exterior portion of the permeable filter 103. The reservoir cavity 102 may also include compression ridges 111 to direct the permeable filter 103 into a seated position in the filter recess 112. The compression ridges 111, may also compress the sides of the permeable filter 103 to physically generate a graduated permeability of the filter. Additionally, the reservoir cavity 102 may include a vertical filter post 113 which centers the permeable filter 103 for even distribution of unfiltered water from the reservoir 101.

The reservoir 101 includes a narrower water outlet portion at the bottom of the filter cavity 102. wider water inlet portion as indicated by the narrowing portion of the reservoir cavity 102. At least a portion of the reservoir 101 includes a truncated conical shape shown by reservoir cavity 102. In one embodiment, the lid 105 is mated at the top of the vertical filter post 113 by the mating post lock 121. The reservoir 101 includes a reservoir lid-cavity seal 109 to seal the lid 105, when locked to prevent unfiltered water from improper entry to the reservoir cavity 102 and thus the permeable filter 103.

Lid

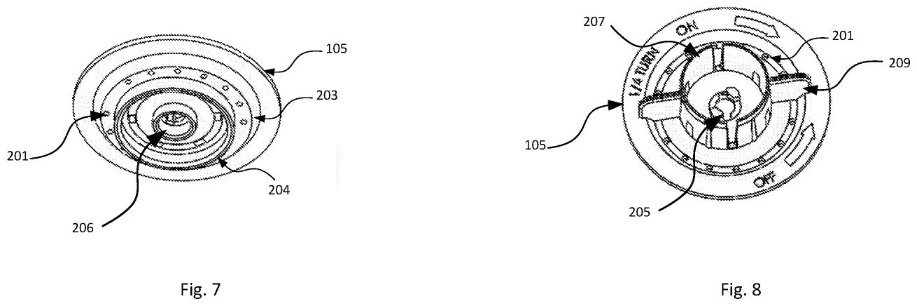

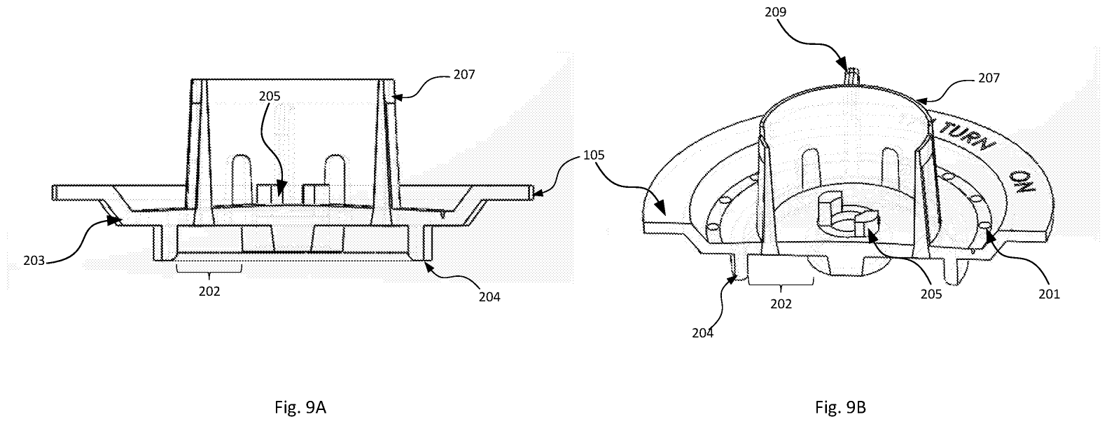

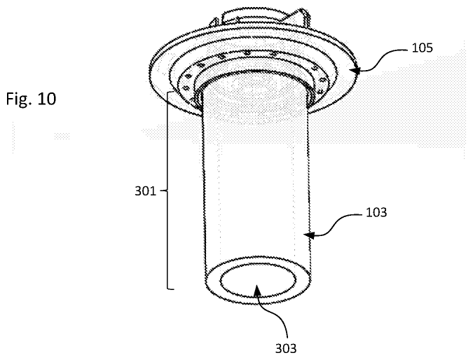

The lid 105 is further detailed, as shown in FIGS. 1, 2A, 2B, 3, and 7-10. A lid 101 is provided at the top of the permeable filter 100. The lid 105 is designed and manufactured to compress and/or contain the permeable filter 103 in the reservoir 101. The lid 105 may generally be planar with a shape similar to the general shape of the reservoir 101. The lid 105 includes entry holes 201, a permeable filter seating section 202, recessed section 203, seating sidewall 204, mated lid portion 205, post seating section 206, central lid wall 207, and wing 209. As shown in FIG. 7, the lid 105 includes holes 201 evenly, radially spaced along a recessed section 203 to allow ingress of unfiltered water added to the reservoir 101 into the reservoir cavity 102. The recessed section 203 may be centered around a centermost point of the lid 105. The centermost point is near the mated lid portion 205. As shown in FIG. 9A, the permeable filter seating section 202 is defined by a seating sidewall 204 and post seating section 206 which extend from the plane of the lid 105 to secure the lid 105 and the permeable filter 103 to the reservoir 101. As shown in FIG. 10, the lid 105 and permeable filter 103 are seated together as directed/defined by the post seating section 206 and seating sidewall 204. In some embodiments, not illustrated, the filter seating section 202 may include a lid seal to cooperate with the permeable filter 103 to seal the unfiltered water from the filtered water near the top of the reservoir cavity 102.

The lid 105 may include a lid turning mechanism that includes a central lid wall 207 which extends from the plane of the lid 105 to support wings 209 utilized to turn/lock the lid 105 in place. The central lid wall 207 and wings 209 also provide a portion for users to more easily grasp the lid 105. In other embodiments, the lid turning mechanism may include mating portions for other turning devices, such as a removable handles or other extending walls that aid a user in turning the lid to lock in place on the reservoir 101.

The lid 105 may include a mated lid portion 205 to the mating post lock 121. The mated lid portion 205 may be turned on to the mating post lock 121 and include a compression fitting to lock the lid 105 to the reservoir 101. The lid 105 may be turned anywhere between 0 and 180 degrees to lock the lid 105 to the reservoir 101, however, generally between 45 and 135 degrees is preferable. Even more preferably, the lid locks at around 90 degrees or a quarter turn. The lid 105 is turned using wings 209 as leverage.

In other embodiments, the locking mechanism may include any type of lock which compresses and seals the lid 105 to the reservoir 101. Other such locking mechanisms may include a latch or pin to hold the lid in place. In other embodiments, the locking mechanism is along the outer edge of the lid 105, as a screw compression lock to seal the lid 105 to the reservoir lid-cavity seal 109 and direct the unfiltered water in the reservoir 101 to only enter the reservoir cavity 102 through holes 201.

Filter

The permeable filter 103 is chosen based upon the requirements of the water purification quality. The permeable filter 103 can be chosen from any number of permeable filters. The filters may be in a The filters may include layer-able materials, which may include sorption media (e.g., activated carbon, synthetic zeolite, schungite, and the like); ion exchange media (e.g., ion exchange resins and the like), porous media (e.g., polypropylene, membranes, filter paper, and the like), catalytic media (e.g., KDF and the like), a disinfecting resin (e.g., iodine resin and the like) and other filters combining properties of media of different compositions. The filter can be selected and used to remove impurities such as bacteria, heavy metals, chlorine, organic impurities, inorganic impurities, radiological impurities, and the like.

The filter may be any number of foam or foam-like materials which are water permeable. The filter media may include layers formed between and/or incorporated into permeable membranes. The filter can be separated into individual layers or a mixed combination of materials which may be in the form of a single permeable filter. The filters of the invention can include more than one layer of a specific filter media, however the layers may be mechanically or chemically interlocked, such as through friction adhesion or chemical bonding. The activated carbon filter media may be a foam filter layer of various thickness which meets the filtering requirements of the water filter system 100.

The filter may include a directional seal that runs along the outer surface or diameter of the filter. In other embodiments, the filter may include a directional seal the runs along the inner surface or diameter of the filter. The directional seal prevents filtered water from returning upstream along the flow path. For example, when the filter is submerged, water that has been filtered does not pass through the filter again.

A redox alloy layer may also be incorporated in the permeable filter 100. The redox alloy layer can be positioned near one or both the exterior surface 301 or internal surface 303 of the permeable filter or mixed into the carbon layer. The redox alloy layer is designed and manufactured to prevent the growth of mold, mildew, and bacteria in the water, in the permeable filter, and in the filter materials. One example of the redox alloy layer includes a KDF (kinetic degradation fluxion) alloy, or other high purity alloys of copper and zinc. One example of the redox alloy layer includes flaked or granulated particulates incorporated into the foam filter.

A mixed ion exchange resin is also included in the permeable filter 100. The mixed ion exchange resin is designed and manufactured to eliminate inorganic elements among other things. One example of the mixed ion resin includes porous structures with large surface area per volume characteristics. One example mixed ion resin in accordance with the invention includes approximately one-half anions and one-half cations. The mixed ion resin includes a highly developed structure of pores. On the surface of the pores, there are sites with easily trapped and released ions. The trapping of ions takes place with simultaneous releasing of other ions. That is the ion-exchange. Cations can be replaced with hydrogen ions, and anions can be replaced with hydroxyls. The hydrogen ions and the hydroxyls can recombine producing water molecules.

Additionally, dividers can be added between the filter layers to further promote the even or uneven flow of water through the filter. The dividers may be thin layers that configure the filter with a graduated permeability. The permeable filter 103 may also include a graduated density which decreases permeability as water runs from the top of the permeable filter 103 to the bottom of the permeable filter 103.

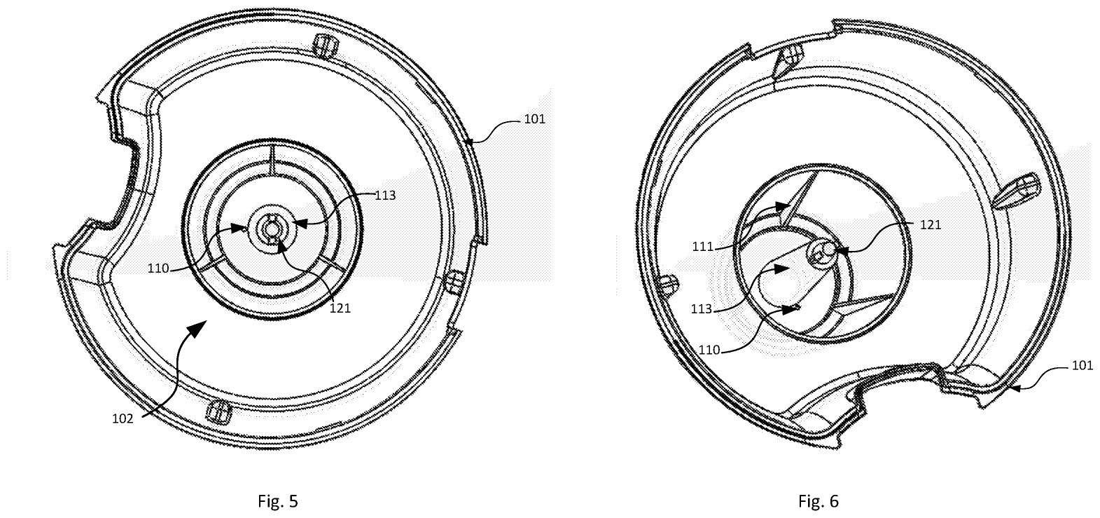

FIGS. 1-6 show the reservoir 101 of the filter system 100 in greater detail. The reservoir 101 includes a cavity 102 for insertion and removal of the permeable filter 103. The reservoir 101 includes a vertical filter post 113 with a post lock 121 at the top to mate with a lid 105 and provides a mechanism to lock to the lid 105 to the post 113 and seal the cavity 102 to direct water through the lid 105 to the permeable filter 103. FIGS. 5 and 6 show the water outlet 110 at the bottom of the cavity 102.

FIGS. 2A, 2B, 3, and 7-10 show the lid 105 of the filter system 100 in greater detail. The lid 105 includes at least a deploying mechanism, a locking mechanism, and unfiltered water entryway. The deploying mechanism includes portions for grasping the lid 105 to aid in insertion and removal of the lid, e.g., wings 209. The deploying mechanism may also be used to actuate the locking mechanism or aid in stabilizing the lid to actuate the locking mechanism, e.g., turning the lid for a compression lock or to hold the lid in place while latching the lid 105 to the reservoir 101. Further, the entryway may include holes 201 or other fluid ingress to the cavity 102 capturing the permeable filter 103.

FIGS. 1, 4, and 10 show permeable filter 103 of the filter system 100 in greater detail. The permeable filter 103 is seated within the lid 105 and reservoir 101. The vertical filter post 113 is concentric to the permeable filter 103. Unfiltered water from the reservoir 101 enter the permeable filter 103 from an exterior surface 301 and exits as filtered water from the interior surface 303. The water outlet 110 of the reservoir 101 and the holes 201 of the lid 105 are sealed from one another using the permeable filter 103. This sealing occurs due to compression of the permeable filter 103 between the lid 105 and bottom of the reservoir cavity 102.

The water reservoirs of the invention can be integrated into containers that house and store filtered water for water treatment apparatuses. These water containers can be in fluid communication with the water reservoir to receive and collect the filtered water from the water outlet of the reservoir. The filtered water can be stored in the water container for future use. As shown in FIG. 11, some example water containers that can be integrated with the water filters of the invention include pitchers 606, 616, 626, travel bottles 636, sports bottle, a water cooler 646, a water jug 656, and a water bottle 666.

The example embodiments of the claimed systems, devices, and methods of filtering liquids with replaceable permeable filters for improved performance, provide improved taste of the filtered water, and make the use of the filter systems easier for customers.

We claim:

1. A water filtration system, comprising:
a permeable filter for filtering water; and
a water reservoir defining a filter cavity, the water reservoir including a filter lid to contain the permeable filter in the cavity defined by the lid and the water reservoir,
wherein the lid is positioned at a filter inlet directing unfiltered water from the water reservoir to the filter, and the filter is fully extended between the lid and an outlet base, the outlet base including a filter outlet of the water reservoir, the water reservoir directs the unfiltered water through the filter to the filter outlet.

2. The system of claim 1, wherein the lid rotates to lock in place.

3. The system of claim 1, wherein the filter is compressible at least 0.01 inches along a central axis of the filter.

4. The system of claim 1, wherein the filter includes a directional seal along an outer surface of the filter.

5. The system of claim 1, wherein the filter includes a directional seal along an inner surface of the filter.

6. The system of claim 1, wherein the filter outlet is open to filtered water.

7. The system of claim 1, wherein the filter includes a graduated permeability.

8. The system of claim 5, wherein the filter is more permeable near the filter outlet than the filter inlet.

9. The system of claim 1, wherein the filter has a cylindrical shape.

10. A water filter reservoir, comprising:
a filter cavity defined by the reservoir; and
a filter lid to contain a permeable filter in the cavity defined by the lid and the water reservoir, wherein the lid is positioned at a filter inlet directing unfiltered water from the water reservoir to the filter, and the filter is fully extended between the lid and an outlet base, the outlet base including a filter outlet of the water reservoir, the water reservoir directs the unfiltered water through the filter to the filter outlet.

11. The water filter reservoir of claim 10, wherein the lid rotates to lock in place.

12. The water filter reservoir of claim 10, wherein the filter is compressible at least 0.01 inches along a central axis of the filter.

13. The water filter reservoir of claim 10, wherein the filter includes a directional seal along an outer surface of the filter.

14. The water filter reservoir of claim 10, wherein the filter includes a directional seal along an inner surface of the filter.

15. The water filter reservoir of claim 10, wherein the filter outlet is open to filtered water.

16. The water filter reservoir of claim 10, wherein the filter includes a graduated permeability.

17. The water filter reservoir of claim 15, wherein the filter is more permeable near the filter outlet than the filter inlet.

18. The water filter reservoir of claim 10, wherein the filter has a cylindrical shape.
